(19) United States
(12) Patent Application Publication
(10) Pub. No.: US 2022/0374927 A1
(43) Pub. Date: Nov. 24, 2022

(54) METHODS AND SYSTEMS FOR PREDICTING PANIC STATES OF MERCHANTS

(71) Applicant: Mastercard International Incorporated, Purchase, NY (US)

(72) Inventors: Ankur Arora, Delhi (IN); Harsimran Bhasin, Delhi (IN); Siddhartha Asthana, Uttar Pradesh (IN); Hardik Wadhwa, Haryana (IN); Tanmoy Bhowmik, Karnataka (IN); Karamjit Singh, Haryana (IN)

(21) Appl. No.: 17/750,380

(22) Filed: May 22, 2022

(30) Foreign Application Priority Data
May 24, 2021 (IN) 202141023090

(51) Int. Cl. G06Q 30/02

(52) U.S. Cl. CPC G06Q 30/0202

(57) ABSTRACT

Embodiments provide methods and systems for predicting panic situation in a region and detecting panic states of merchants in the region. Method performed by server system includes accessing payment transaction data associated with merchants from transaction database and identifying panic trigger indicating panic situation in region based on transaction features associated with merchants. In response to identifying panic trigger, method includes generating transaction features based on payment transactions of merchant over time duration and determining association between merchant and merchant cluster based on transaction features associated with merchant. Method includes predicting time-series transaction data associated with merchant based on deep neural network model and merchant cluster associated with merchant, and calculating error between predicted time-series transaction data and real time-series transaction data associated with merchant. Method further includes identifying panic state for merchant based on error between predicted time-series transaction data and real time-series transaction data of merchant.

### RELATED APPLICATIONS

This application claims priority to Indian Patent Application No. 202141023090, filed May 24, 2021, which is incorporated herein by reference in its entirety.

### TECHNICAL FIELD

The present disclosure relates to artificial intelligence processing systems and, more particularly to, electronic methods and complex processing systems for predicting panic in a region and determining panic states of one or more merchants in the region.

### BACKGROUND

Sometimes, various events (such as terrorist attacks, rumors, disease outbreak, pandemic inclement weather forecast, local hazard etc.) may result into public panic. In most cases, the public panic may result unplanned purchase behaviors of buyers which impacts markets negatively. In many cases, this may lead to a situation of hoarding of goods, or shortage of goods resulting in out of stock situations in merchant stores. This results in decline in sales and transactions. Sometimes, hoarding and out of stock situations also result in bad user experience due to which merchants lose their valuable customers. The situation of hoarding due to public panic also poses a threat to food security as well as availability of essential commodities in a region.

Therefore, panic prediction and detection becomes essential to avoid the above-mentioned situations. Existing technologies attempt to detect panic with limitations of detecting panic in open spaces, using sensors and camera. This makes detecting panic in larger region a very costly affair and infeasible. The existing technologies only detect out of stock situation. Further, the out of stock situation detected in the existing systems is for a shelf rather than for a merchant. In addition, the existing technologies fail to differentiate between a fake and real panic, thereby making panic detection ineffective.

Therefore, there is a requirement of a system or a method that is generalizable to predict and detect public panic of all types in a feasible and effective manner. More particularly, there is a technological need for a technical solution to detect and predict a real panic, so as to assist merchants for effective management of stock.

### SUMMARY

Various embodiments of the present disclosure provide systems, methods and electronic devices for predicting a panic situation in a region and panic states of merchants in the region proactively using machine learning techniques.

In an embodiment, a server system is disclosed. The server system includes a communication interface, a memory including executable instructions, and a processor communicably coupled to the communication interface and the memory. The processor is configured to execute the executable instructions to cause the server system to access payment transaction data associated with a plurality of merchants from a transaction database, and identify a panic trigger indicating a panic situation in a region based, at least in part, on transaction features associated with the plurality of merchants. The server system is further caused to generate transaction features based on payment transactions of at least one merchant of the plurality of merchants over a time duration in response to identifying the panic trigger. The server system is further caused to determine an association between the at least one merchant in the region and at least one merchant cluster based, at least in part, on the transaction features associated with the at least one merchant and predict time-series transaction data associated with the at least one merchant based, at least in part, on a deep neural network model and the at least one merchant cluster associated with the at least one merchant. The server system is further caused to calculate an error between the predicted time-series transaction data and a real time-series transaction data associated with the at least one merchant. The real time-series transaction data is generated based, at least in part, on payment transaction data of the at least one merchant stored in the transaction database. The server system is further caused to identify a panic state for the at least one merchant based on the error between the predicted time-series transaction data and the real time-series transaction data of the at least one merchant.

In another embodiment, a computer-implemented method is disclosed. The computer-implemented method performed by a server system includes accessing payment transaction data associated with a plurality of merchants from a transaction database. The method includes identifying a panic trigger indicating a panic situation in a region based, at least in part, on transaction features associated with the plurality of merchants and generating transaction features based on payment transactions of at least one merchant of the plurality of merchants over a time duration. The method includes determining an association between the at least one merchant in the region and at least one merchant cluster based, at least in part, on the transaction features associated with the at least one merchant and predicting time-series transaction data associated with the at least one merchant based, at least in part, on a deep neural network model and the at least one merchant cluster associated with the at least one merchant. The method includes calculating, by the server system, an error between the predicted time-series transaction data and a real time-series transaction data associated with the at least one merchant. The real time-series transaction data is generated based, at least in part, on payment transaction data of the at least one merchant stored in the transaction database. The method includes identifying, by the server system, a panic state for the at least one merchant based on the error between the predicted time-series transaction data and the real time-series transaction data of the at least one merchant.

### BRIEF DESCRIPTION OF THE FIGURES

For a more complete understanding of example embodiments of the present technology, reference is now made to the following descriptions taken in connection with the accompanying drawings in which:

FIG. 1 is an example representation of an environment, related to at least some example embodiments of the present disclosure;

FIG. 2 is a simplified block diagram of a server system, in accordance with one embodiment of the present disclosure;

FIG. 3 is a schematic block diagram representation of panic detection and prediction process, in accordance with an example embodiment of the present disclosure;

FIG. 4 is a schematic block diagram representation of the panic states determination, in accordance with an example embodiment of the present disclosure;

FIG. 5 is a schematic representation of a deep neural network model, in accordance with an example embodiment of the present disclosure;

FIG. 6 is a flow chart for training phase, in accordance with an example embodiment of the present disclosure;

FIGS. 7A and 7B are flow charts of a computer-implemented method for predicting a panic in a region and determining panic state of a merchant in the region, in accordance with an example embodiment of the present disclosure; and

FIG. 8 is a simplified block diagram of an acquirer server, in accordance with an example embodiment of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “payment network”, used herein, refers to a network or collection of systems used for the transfer of funds through use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes that may include payment cards, letters of credit, checks, financial accounts, etc. Examples of networks or systems configured to perform as payment networks include those operated by such as, Mastercard®.

The term “merchant”, used throughout the description generally refers to a seller, a retailer, a purchase location, an organization, or any other entity that is in the business of selling goods or providing services, and it can refer to either a single business location, or a chain of business locations of the same entity.

The terms “cardholder”, “card member”, and “customer” are used interchangeably throughout the description, and refer to a person who holds a credit or a debit card that will be used by a merchant to perform a payment transaction.

The term “panic state” relates to merchant-specific situations (such as out of stock, hoarding, panic buying, etc.) in panic situations in a region.

Overview

Various example embodiments of the present disclosure provide methods, systems, user devices and computer program products for predicting panic in a region and determining panic states of one or more merchants in the region. In particular, the present disclosure enables detecting and predicting panic in the region using insights from payment transaction data of the one or more merchants of the region. Once the panic situation is analyzed in the region, the system determines merchant-specific situation or panic state of the merchants (e.g., out-of-stock, hoarding, etc.) in the region which helps the merchants in management of stock to avoid out of stock or hoarding situations.

In an example, the present disclosure describes a server system that is configured to access payment transaction data associated with one or more merchants from a transaction database. The server system is configured to extract transaction features from the payment transaction data. The payment transaction data includes information of payment transactions between a plurality of customers and the one or more merchants for a period of time. The server system is configured to detect a panic level in the region based, at least in part, on the extracted transaction features and an average rate of change in spend at the one or more merchants for the period of time. When the panic level is above a pre-determined threshold value, the server system is configured to access information from one or more external databases (such as, government data, open-source data, public healthcare data, news, and weather forecast data, etc.) and determine a cause of probable panic based, at least in part, on the analysis of information by a natural language processing (NLP) model.

In one embodiment, the server system is configured to predict the panic in the region based on root-cause analysis of the probable panic and generate the panic trigger for indicating the panic in the region.

In response to identification of the panic trigger, the server system is configured to determine panic state of a merchant based on its transaction features over a time duration. In particular, the server system is configured to generate transaction features (i.e., merchant transaction attributes) based on payment transactions of at least one merchant. The transaction features may be, but are not limited to, total purchase amount for a pre-determined duration spent at each merchant, total purchase amount spent by a plurality of customers possessing different card types for the pre-determined duration, total number of transactions by the plurality of customers having different card types within the pre-determined duration, total number of online transactions performed at each merchant within the pre-determined duration, and total numbers of transactions involving a payment card at each merchant within the pre-determined time duration.

Thereafter, the server system is configured to determine an association between the at least one merchant and at least one merchant cluster of a plurality of merchant clusters based on the transaction features. In other words, the server system is configured to find the closest merchant cluster for the at least one merchant based on the sales behavior, merchant category, etc. The server system is configured to predict time-series transaction data of the at least one merchant based, at least in part, on a deep neural network model and the at least one merchant cluster. The deep neural network model includes marked temporal point process (TPP) models with intensity free learning method, and each marked TPP model corresponds to each merchant cluster.

In one embodiment, the server system is configured to provide the transaction features and two dimensional (2D) marker associated with the at least merchant to a cluster-specific marked TPP model associated with the at least one merchant cluster. The 2D marker is characterized by transaction amount and merchant identifier of the at least one merchant. Thus, the server system is configured to predict the time-series transaction data associated with the at least one merchant by the cluster-specific marked TPP model.

Subsequent to determining the predicted time-series transaction data of the at least one merchant, the server system is configured to calculate an error between the predicted time-series transaction data and real time-series transaction data associated with the at least one merchant. Based on the error, the server system is configured to identify a panic state for the at least one merchant which can be one of: panic buying, out-of-stock, hoarding, or normal.

Various embodiments of the present disclosure offer multiple advantages and technical effects. For instance, the present disclosure provides a system for predicting the panic level using merchant transaction data but also alerting whether the panic is real or fake using external databases. To improve the veracity of the predicted panic, the present disclosure also analyzes panic reasons by finding root cause from open source data. The present disclosure helps in differentiating between merchant panic states such out-of-stock, hoarding or normal. By detecting abnormal trend change in a specific merchant, the present disclosure helps to reduce false alarm for the specific merchant when change is due to external factors. The present disclosure provides a novel approach to utilize 2D markers in marked TPP model in financial domain. The 2D marker builds a group model rather than computing intensive merchant specific model.

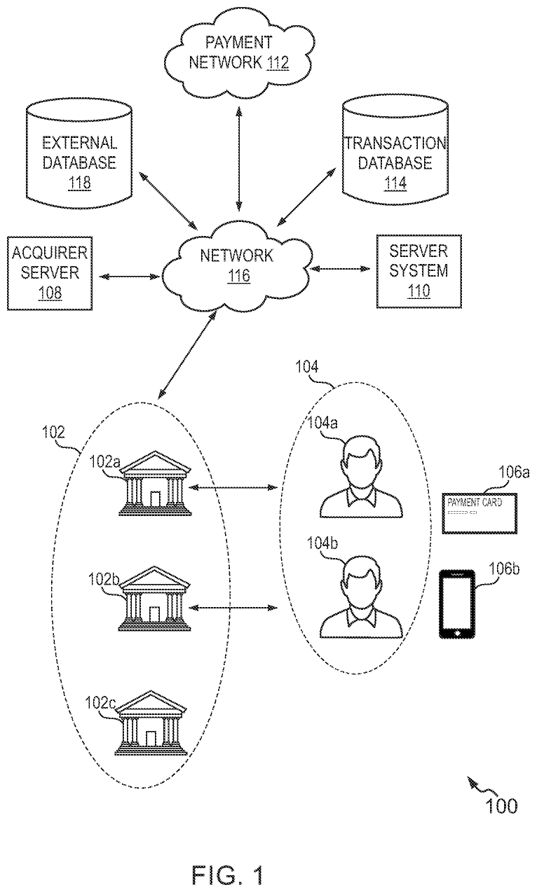

Various example embodiments of the present disclosure are described hereinafter with reference to FIGS. 1 to 8.

FIG. 1 illustrates an exemplary representation of an environment 100 related to at least some example embodiments of the present disclosure. Although the environment 100 is presented in one arrangement, other embodiments may include the parts of the environment 100 (or other parts) arranged otherwise depending on, for example, classifying a panic situation and detecting abrupt merchant behaviors based on the panic situation. The environment 100 generally includes a plurality of entities, for example, a plurality of merchants 102a, 102b, and 102c and an acquirer server 108, a payment network 112, and a transaction database 114 each coupled to, and in communication with (and/or with access to) a network 116. The network 116 may include, without limitation, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, a virtual network, and/or another suitable public and/or private network capable of supporting communication among the entities illustrated in FIG. 1, or any combination thereof.

Various entities in the environment 100 may connect to the network 116 in accordance with various wired and wireless communication protocols, such as Transmission Control Protocol and Internet Protocol (TCP/IP), User Datagram Protocol (UDP), 2^{nd}Generation (2G), 3^{rd} Generation (3G), 4^{th} Generation (4G), 5^{th} Generation (5G) communication protocols, Long Term Evolution (LTE) communication protocols, or any combination thereof. For example, the network 116 may include multiple different networks, such as a private network made accessible by the payment network 112 to the acquirer server 108, separately, and a public network (e.g., the Internet etc.).

The environment 100 also includes a server system 110 configured to perform one or more of the operations described herein. In one example, the server system 110 is embodied in the payment network 112. In general, the server system 110 is configured to detect a panic in a region. The server system 110 is also configured to determine if the panic is real or fake, and to predict a panic by determining the root cause of the detected panic. In addition, the server system 110 is configured to determine panic states or merchant-specific panic situations as being one of: out of stock, hoarding, panic buying, and normal. The server system 110 is a separate part of the environment 100, and may operate apart from (but still in communication with, for example, via the network 116) the acquirer server 108, the payment server, and any third party external servers (to access data to perform the various operations described herein). However, in other embodiments, the server system 110 may actually be incorporated, in whole or in part, into one or more parts of the environment 100, for example, the acquirer server 108. In addition, the server system 110 should be understood to be embodied in at least one computing device in communication with the network 116 that may be specifically configured, via executable instructions, to perform steps as described herein, and/or embodied in at least one non-transitory computer-readable media.

In one embodiment, a plurality of merchants 102a, 102b, and 102c is associated with the acquirer server 108. The plurality of merchants 102a, 102b, and 102c hereinafter is collectively represented as “merchant 102”.

The merchant 102 may have a plurality of customers that may use payment cards or may use online modes to perform transactions at the merchant physical store or online store. For example, as shown in FIG. 1, customers 104a and 104b are the customers associated with the merchants 102a and 102b. Further, the customer 104a may possess a payment card 106a. The customer 104b may possess a user device 106b which is used to perform online payment transactions through merchant's online webstore. The plurality of customers 104a and 104b hereinafter is collectively represented as “customer 104”. The customer 104 may be any individual, representative of a corporate entity, non-profit organization, or any other person. It is to be noted that a merchant can have plurality of customers (or cardholders) that use payment cards to make payment transactions as well as customers that use online modes for example mobile application, or webpage to make online payment transactions.

To accept payment transactions from the customers, the merchant 102 normally establishes an account with a financial institution (i.e., “acquirer server 108”) that is part of the financial payment system. Account details of the merchant accounts established with the acquirer bank are stored in merchant profiles of the merchants in a memory of the acquirer server 108 or on a cloud server associated with the acquirer server 108. It shall be noted that all the merchants 102a-102c may not be associated with a single acquirer and the merchants may establish financial accounts with different acquirers and thereby payment transactions may be facilitated by more than one acquirer server and have not been explained herein for the sake of brevity.

In one embodiment, the acquirer server 108 is associated with a financial institution (e.g., a bank) that processes financial transactions. This can be an institution that facilitates the processing of payment transactions for physical stores, merchants, or an institution that owns platforms that make online payments or payments made via software applications possible (e.g., shopping cart platform providers and in-app payment processing providers). The terms “acquirer”, “acquirer bank”, “acquiring bank” or “acquirer server” will be used interchangeably herein.

In one embodiment, in order to detect panic situation in a region, the server system 110 accesses payment transaction data associated with a plurality of merchants for a pre-determined time period from the transaction database 114. The payment transaction data is processed and certain transaction features are extracted from it. The extracted transaction features are then used to classify panic level in a region. For example, a high panic level may be indicated as level 5, and the lowest panic level may be indicated as level 1.

Once the high panic level is detected, the server system 110 accesses data from one or more external databases 118 as shown in FIG. 1. The external databases 118 may include data from various sources such as, but not limited to, government sources, news, articles, weather forecast, healthcare related sources, public sourced news, open source projects etc. The server system 110 is configured to utilize the data from the external databases 118 to find out root cause of the detected panic. Based on the root cause of the detected panic, the server system 110 predicts a panic by determining that the situation of panic is real or fake.

Once the server system 110 identifies a panic (i.e., a real panic) in the region in future, the payment transaction data associated with a plurality of merchants 102 is pre-processed to arrange in a time-series manner. The server system 110 is configured to form a plurality of merchants clusters based on an average rate of change in spend (or payment transactions) associated with each merchant. For example, all the merchants having less rate of change in spend behavior will be grouped in one cluster. The server system 110 is configured to perform an intensity free learning of temporal point process over the plurality of merchant clusters to predict time-series transaction data for each merchant cluster.

Subsequent to determining the predicted time-series transaction data for each merchant, real time-series or actual time-series transaction data of each merchant is accessed from the transaction database 114 and is compared with the predicted time-series transaction data. Thus, an error between the two time-series is calculated that is used to categorize a panic state of the merchant 102 as one of: out of stock, panic buying, or hoarding.

In one embodiment, the payment network 112 may be used by the payment cards issuing authorities as a payment interchange network. The payment network 112 may include a plurality of payment servers. Examples of payment interchange network include, but are not limited to, Mastercard® payment system interchange network. The Mastercard® payment system interchange network is a proprietary communications standard promulgated by Mastercard International Incorporated® for the exchange of financial transactions among a plurality of financial activities that are members of Mastercard International Incorporated®. (Mastercard is a registered trademark of Mastercard International Incorporated located in Purchase, N.Y.).

In one embodiment, the transaction database 114 is a central repository of data associated with the acquirer 108 or the payment network 112 that is created by storing payment transaction data (i.e., purchase transaction data) associated with financial transactions between a plurality of merchants and their associated customers from financial transactions occurring within acquirers and issuers associated with the payment network 112. The payment transaction data associated with each merchant may include, but is not limited to, merchant transaction attributes, such as, transaction identifiers, payment card type (debit/credit/prepaid), card product types, transaction amounts, transaction time information, type of payment transaction (i.e., involving a payment card or online payment transaction), merchant category, geographical location, type of industry associated with merchant etc.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems (e.g, one or more systems) or a set of devices (e.g., one or more devices) of the environment 100 may perform one or more functions described as being performed by another set of systems or another set of devices of the environment 100.

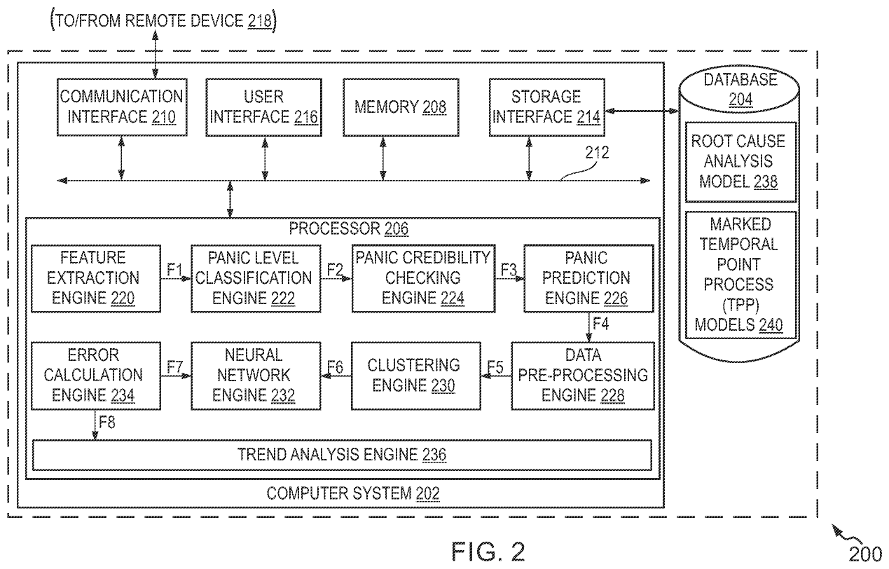

FIG. 2 is a simplified block diagram of a server system 200, in accordance with an embodiment of the present disclosure. The server system 200 is similar to the server system 110 as shown in FIG. 1. In some embodiments, the server system 200 is embodied as a cloud-based and/or SaaS-based (software as a service) architecture. In one embodiment, the server system 200 is a part of a payment network 112 or is integrated within a payment server. In another embodiment, the server system 200 is embodied within the acquirer server 108.

The server system 200 includes a computer system 202 and a database 204. The computer system 202 includes at least one processor 206 for executing instructions, a memory 208, a communication interface 210, and a user interface 216 that communicate with each other via a bus 212.

In some embodiments, the database 204 is integrated within the computer system 202. For example, the computer system 202 may include one or more hard disk drives as the database 204. A storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204.

Examples of the processor 206 include, but are not limited to, an application-specific integrated circuit (ASIC) processor, a reduced instruction set computing (RISC) processor, a complex instruction set computing (CISC) processor, a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200, without departing from the scope of the present disclosure.

The processor 206 is operatively coupled to the communication interface 210, such that the processor 206 is capable of communicating with a remote device 218 such as, the merchant 102, or communicated with any entity connected to the network 116 (as shown in FIG. 1). Further, the processor 206 is operatively coupled to the user interface 216 for detecting and predicting a panic in a region and for predicting panic state of a merchant as one of: panic buying, hoarding, out of stock, and normal.

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one embodiment, the processor 206 includes a feature extraction engine 220, a panic level classification engine 222, a panic credibility checking engine 224, a panic prediction engine 226, a data pre-processing engine 228, a clustering engine 230, a neural network engine 232, an error calculation engine 234, and a trend analysis engine 236. It should be noted that the components, described herein, can be configured in a variety of ways, including electronic circuitries, digital arithmetic and logic blocks, and memory systems in combination with software, firmware, and embedded technologies.

The database 204 may include various models which may be fetched by various engines of the processor 206. For example, the database 204 may include a root cause analysis model 238, and marked temporal point process (TPP) models 240.

The feature extraction engine 220 includes suitable logic and/or interfaces for accessing payment transaction data of a plurality of merchants 102a-102c for a pre-determined period of time (e.g., a week) in a particular region (i.e. in a geographical region). The feature extraction engine 220 is configured to access the payment transaction data from a transaction database (e.g., the transaction database 114). In particular, the payment transaction data associated with the merchant 102 may include, but not limited to, cardholder identifiers, card product types, merchant identifier, spending amounts of payment transactions, time/date stamps associated with the payment transactions, etc.

In one example, the payment transaction data may include spend transactions across different merchant categories (such as, grocery, airlines, etc.), merchant industries (i.e., aggregated merchant categories such as, retail clothing, hotel industry), locations where the spend transactions occurred, payment transaction types (e.g., contactless, card present, etc.) etc.

During the training phase, the payment transaction data is related to payment transactions for the period prior to and including a disaster, or pandemic, or bomb threats due to which panic was created in the past. For example, in case of a disaster like an earthquake, data from time period starting from 21 days prior to the event till the day of the disaster would be fed to the feature extraction engine 220. During the execution phase, payment transaction data of the recent past (e.g., data of past 21 days) is fed to the feature extraction engine 220.

The feature extraction engine 220 is configured to extract transaction features from the payment transaction data. The extracted transaction features may be, but are not limited to, total purchase amount for a pre-determined duration spent at each merchant, total purchase amount spent by a plurality of customers possessing different card types for the pre-determined duration, total number of transactions by the plurality of customers having different card types within the pre-determined duration; total number of online transactions performed at each merchant within the pre-determined duration; and total numbers of transactions involving a payment card at each merchant within the pre-determined time duration.

The feature extraction engine 220 may include a machine learning model such as, but not limited to, Linear Discriminant Analysis (LDA) model, Independent Component Analysis (ICA) model, or Principal Component Analysis (PCA) model.

The panic level classification engine 222 includes suitable logic and/or interfaces for detecting a panic level in the particular region based, at least in part, on the transaction features and an average rate of change in spend at each merchant 102 of the particular region. The panic level classification engine 222 is configured to receive the transaction features from the feature extraction engine (see, F1). The average rate of change in spend at each merchant 102 is calculated. The plurality of merchants 102a-102c is sorted based on this rate. In one example, top 20% merchants having highest change in rate of spend are given panic level 1. The next 20% are given panic level 2 and so on.

The panic level classification engine 222 is configured to classify situations of the particular region into a plurality of panic levels (e.g., 1-5). For example, level 1 may indicate the lowest level of panic while level 5 may indicate the highest level of panic.

In one embodiment, the panic level classification engine 222 may implement multivariate a based classifier model. In one example, the panic level classification engine 222 may implement CatBoost algorithm for determining the panic situation. The multivariate neural network based classifier is trained based on transaction features for previous panic events like past pandemics, bomb threats, etc.

In case the panic level is above a predetermined threshold level, the panic level classification engine 222 is configured to generate a trigger which indicates that a probable panic has been detected in the region. For example, if the panic level is above level 3, the panic level classification engine 222 is configured to generate the trigger.

The panic credibility checking engine 224 includes suitable logic and/or interfaces for receiving the trigger from the panic level classification engine 222 (see F2). In response to the reception of the trigger indicating a detection of the panic situation, the panic credibility checking engine 224 is configured to access information from the external databases 118. The information may be, but is not limited to, government data, open source data, public healthcare data, news, public sourced news, and weather forecast data.

Since, the information is in textual form, therefore, the panic credibility checking engine 224 processes the textual information using natural language processing (NLP) techniques and identifies events like cyclone warnings, threats, disease outbreaks, etc. In particular, the textual information is utilized to extract features by creating embedding from each of the textual information using Doc2vec model.

During the training phase, the panic credibility checking engine 224 is configured to create event clusters based on the events identified through the NLP process. For example, weather-based events can be clubbed into one event cluster, man-made threats can be another event cluster and so on. During the execution phase, when an information (i.e. information from external databases) is obtained, the embedding of the new information is created and its distance from the all the event clusters is calculated.

The panic prediction engine 226 includes suitable logic and/or interfaces for predicting panic in a region by determining if the event that caused the panic is fake or real based on the accessed event clusters from the panic credibility checking engine 224 (see F3). In other words, the panic prediction engine 226 is configured to determine a cause of the probable panic detected by the panic classification engine 224 based, at least in part, on analysis of information by a natural language processing (NLP) model.

If the new information of the region is far away from all the event clusters, the panic prediction engine 226 determines that the event is fake. If the new information of the region falls in one of the event clusters then it provides the root cause of the event that caused the panic based on the root cause analysis model 238. For example, if the new information falls into the event cluster that is characterized by earthquake, then it is determined that the root cause of the panic is an earthquake. The panic prediction engine 226 predicts a panic in the region and generates a panic trigger.

The data pre-processing engine 228 includes suitable logic and/or interfaces for receiving a panic trigger (see, F4) and accessing payment transaction data associated with a plurality of merchants 102a-102c for a period of time (e.g., a week). The payment transaction data of the plurality of merchants is accessed from a transaction database 114. The payment transaction data for a merchant may include information of payment transactions between a plurality of cardholders (e.g., cardholders) and the merchant for the period of time. In particular, the payment transaction data associated with each merchant may include, but not limited to, cardholder identifiers, card product types, merchant identifier, spending amounts of payment transactions, time/date stamps associated with the payment transactions etc.

The data pre-processing engine 228 is configured to extract merchant transaction attributes (i.e., transaction features) from the payment transaction data. In one embodiment, the data pre-processing engine 228 is configured to arrange or aggregate the merchant transaction attributes in a time-series manner to generate a multivariate time-sequence merchant data for each merchant. The merchant transaction attributes may include, but not limited to, time-series sales data during a period of time.

In an exemplary embodiment, the data-preprocessing engine 228 is configured to represent the time-series sales data into multivariate time-series data form based on aggregated sales amount and count of sales. For example, for a merchant A, suppose the aggregated sales in the months from January to June are $4500, $3000, $5000, $2600, $3400, $4000, and the counts of sales for those months are 150, 200, 370, 90, 125, and 145, respectively. Therefore, the time-series data of the merchant transaction attributes for the time period from January to June would be represented as (4500, 150), (3000, 200), (5000, 370), (2600, 90), (3400, 125), and (4000, 145).

During the training phase, the clustering engine 230 includes suitable logic and/or interfaces for generating a plurality of merchant clusters based, at least in part, on the multivariate time-series data associated with the plurality of merchants of the particular region. The multivariate time-series data is received from the data pre-processing engine (see, F5). More particularly, the clustering engine 230 is configured to cluster similar kind of merchants with similar merchant transaction attributes into one cluster. Each merchant cluster includes one or more merchants with similar characteristics such as, type of purchase behavior. Therefore, the plurality of merchant clusters is formed wherein each cluster has merchants possessing similar merchant transaction attributes. Merchants experiencing similar type of purchase behavior fall under one cluster. For example, there are 1000 merchants in the region where the panic situation is detected. At first, the data pre-processing engine 228 accesses sales data associated with the merchants over a period of time and formulates time-series data associated with each merchant based on the sales data. The clustering engine 230 then clusters the merchants based at least on similar sales behavior, popularity index of each merchant in the region, merchant category, etc. into 50 different clusters.

The goal of the clustering process is to identify a merchant cluster to which at least one merchant 102 belongs given the multivariate time-series data of the at least one merchant.

In general, clustering refers to grouping of similar type of data into one cluster. Soft clustering refers to the clustering process in which one or more clusters may overlap with each other. For example, a merchant may belong to two or more clusters at the same time. In some embodiments, it shall be noted that the clustering engine 230 may use K-means, Gaussian Mixture Model (GMM) based clustering, Dirichlet Multinomial Mixture (DMM) based clustering, etc. In one embodiment, the clustering engine 230 may utilize dynamic time warping (DTW) with hierarchical clustering methods. In general, the DTW finds the optimal non-linear alignment between two time-series data.

In one example, the hierarchical clustering is preferred because it allows the multivariate time-series data to be grouped in different levels automatically that helps a user to explore the structure of the groupings from coarse to refined. This is particularly useful when the grouping structure is not known in advance. The hierarchical clustering does not require the number of clusters to be predefined at the beginning; it allows the data to decide the suitable number of groups by themselves.

The clustering engine 230 includes suitable logic and/or interfaces for calculating an association between the merchant transaction attributes and one or more merchant clusters based, at least in part, on the aggregated merchant transaction attributes of a merchant by applying a clustering model over the merchant transaction attributes. In an exemplary embodiment, during the execution phase, a distance of the data point values associated with the merchant 102 (hereinafter referred to as merchant data point value) from a centroid of each of the clusters is calculated. Based on the distance, the merchant is assigned into one of the merchant clusters. In other words, the processor 206 is configured to determine an association between the merchant 102 and at least one merchant cluster based, at least in part, on the time-series transaction data associated with the merchant 102.

During the training, the processor 206 is also configured to generate a combined multivariate time-series data corresponding to each merchant cluster. The neural network engine 232 includes suitable logic and/or interfaces for predicting time-series transaction data associated with a merchant 102 based on a deep neural network model and a merchant cluster associated with the merchant 102. The deep neural network model may include cluster-specific marked temporal point process (TPP) models 240.

In other words, the neural network engine 232 is configured to utilize single marked TPP model for each merchant cluster. For example, there are 1000 merchants in the region where the panic situation is detected. The clustering engine 230 generates 50 merchant clusters based at least on similar sales behavior, popularity index of each merchant in the region, merchant category, etc. The neural network engine 232 then utilizes 50 different marked TPP models.

In general, the TPP model is a generic framework for asynchronous time-series data that allows modelling of inter event time as continuous random variable. A temporal point process (TPP) is a random process whose realizations consist of a sequence of strictly increasing arrival times T={t1, . . . , tN}. The TPP can be represented as a sequence of strictly positive inter-event times τᵢ=tᵢ−tᵢ−1. The traditional way of specifying the dependency of the next arrival time t on the history Ht={tj∈T: tj<t} is using the conditional intensity function λ*(t):×λ(t|Ht).

In the present disclosure, the TPP model corresponds to marked TPP model with intensity free learning. In the present disclosure, instead of modelling of conditional density function for each marked TPP model according to the traditional ways, the neural network engine 232 is configured to learn or model conditional distribution p (τ) directly for each marked TPP model without assuming any conditional distribution initially. The goal is to model the distribution over inter-arrival time given the past history of events inter-arrival times i.e., learning to model the conditional distribution.

The concept of marked temporal point process (TPP) model with the transaction sequence example is explained for a better understanding. A sequence of M payment transactions of a merchant cluster τ={(t1, χ1), . . . (ti, χi), . . . (tM, χM)} is an instance of a marked temporal point process, where (t1, . . . tM) refers to a strictly ascending sequence of timestamps, and (χ1, . . . , χi, . . . , χM) is the corresponding sequence of d-dimensional markers (e.g., transactional features, such as, transaction data, merchant identifier, etc.). The symbol xj denotes the domain of definition for χi j i.e., the j-th dimension of mark χi (∀i=1, . . . , M; j=1, . . . , d). The notation τ=(t, χ) denotes the random variables of an event.

During the training phase, the neural network engine 232 is configured to receive the combined time-series transaction data associated with each merchant cluster along with 2D marker (see, F6) which are fed to respective cluster-specific marked TPP models 240. The cluster-specific marked TPP models 240 are configured to learn payment transaction behavior based on the combined time-series transaction data of each merchant cluster. In other words, during the training, the cluster-specific marked TPP models 240 are configured to learn group behavior associated with each merchant cluster.

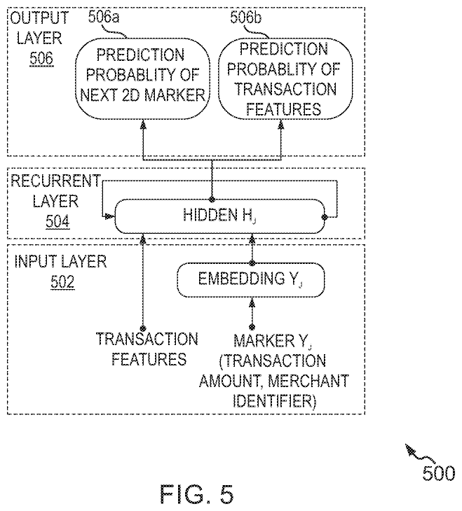

In order to determine future transaction behavior of a specific merchant, the cluster-specific marked TPP model is configured to utilize 2D marker process that allows flexibility to model group behavior while having flexibility to see merchant-specific predictions. Each merchant is associated with a unique merchant identifier (ID). The 2-D marker is characterized by transaction amount and merchant ID. The deep neural network model is explained in detail below with reference to FIG. 5.

The error calculation engine 234 includes suitable logic and/or interfaces for calculating error between real time-series transaction data and predicted time-series transaction data for the merchant 102. The error calculation engine 234 is configured to access the predicted time-series transaction data from the neural network engine 232 (see F7). The error calculation engine 234 is also configured to access real time-series transaction data from the transaction database associated with each merchant. The real time-series transaction data is compared with the predicted time-series transaction data and the time-series error is calculated.

An example of the error calculation engine 234 is Generalized Least Squares (GLS) regression model with an autocorrelation structure. Another example of the error calculation engine 234 is a model using dynamic time warping (DTW), which compares two temporal sequences.

The trend analysis engine 236 includes suitable logic and/or interfaces for predicting panic state of a merchant based at least on the error between the real time-series transaction data and the predicted time-series transaction data. The trend analysis engine 236 is configured to receive the error between the real time-series transaction data and the predicted time-series transaction data from the error calculation engine 234 (see F8). The trend analysis engine 236 is configured to calculate values of one or more parameters, such as, merchant transaction volume, global transaction volume, and transaction mean value. Based on the parameters, the trend analysis engine 236 is configured to predict the panic state of the merchant as being one of: out of stock, panic buying, normal, or hoarding.

In an exemplary embodiment, the trend analysis engine 236 is configured to predict the panic states of the merchant 102 as per the conditions given in Table 1.

TABLE 1

| Merchant | | | |
|---|---|---|---|
| Transaction | Global Transaction | Transaction Mean | |
| Volume | Volume | Value | Prediction Result |
| Positive Shift | Positive Shift | N/A | Panic Buying |
| Positive Shift | Negative Shift | Positive Shift | Hoarding |
| Negative Shift | Positive Shift | N/A | Out of Stock |

If the merchant transaction volume has a positive shift and the global transaction volume has a positive shift, then the trend analysis engine 236 predicts the panic state of the merchant as panic buying. Similarly, if the merchant transaction volume has a negative shift and the global transaction volume has a positive shift, then the trend analysis engine 236 predicts the panic state of the merchant as out of stock. Further, if the merchant transaction volume has a positive shift, the global transaction volume has a negative shift, and the transaction mean value has a positive shift then the trend analysis engine 236 predicts the panic state of the merchant as hoarding. In cases other than the above-mentioned cases, the trend analysis engine 236 predicts the panic state of the merchant as normal.

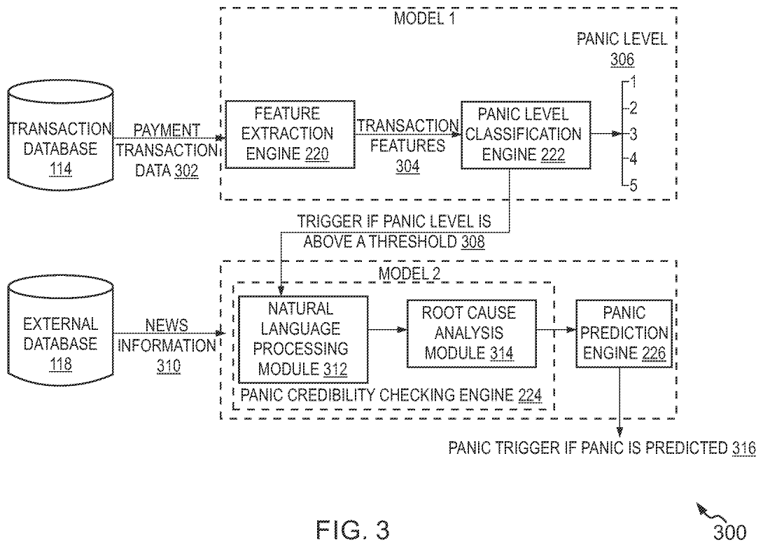

FIG. 3 is a schematic block diagram representation 300 of panic detection and prediction process, in accordance with an example embodiment of the present disclosure. Model 1 as shown in the FIG. 3 includes a feature extraction engine 220 and a panic level classification engine 222 which are collectively responsible to detect the level of panic in a region. As mentioned above, the feature extraction engine 220 receives payment transaction data 302 associated with a plurality of merchants from the transaction database 114. The feature extraction engine 220 extracts the transaction features 304 from the payment transaction data 302. The extracted transaction features 304 are provided to the panic level classification engine 222 which assigns a panic level 306 in the region, based on the average rate of change of spend of plurality of merchants. In case, the panic level 306 is detected more than a pre-determined threshold, then a trigger 308 which activates Model 2 is generated.

Model 2 includes a panic credibility checking engine 224 and panic prediction engine 226. The panic credibility checking engine 224 further includes a natural language processing module 312 and a root cause analysis module 314. The trigger 308 from Model 1 is received by the natural language processing module 312. The natural language processing module 312 accesses news information 310 from the external databases 118. The news information 310 may be, but is not limited to, government data, open source data, public healthcare data, news, public sourced news, and weather forecast data. The natural language processing module 312 processes the textual content in the news information to extract features by creating embedding from each of the textual information using Doc2vec model. The extracted features are utilized to determine one or more events causing panic. Based on the determined events, the root cause analysis module 314 generates event clusters based on the events identified through natural language processing. The panic prediction engine 226 predicts panic in a region by determining if the event that caused the panic is fake or real. If the new information is far away from all the event clusters, the panic prediction engine 226 determines that the event is fake. If the new information falls in one of the event clusters, it provides the root cause of the event that caused the panic. In case it is determined that the panic is real, the panic prediction engine generates a panic trigger 316.

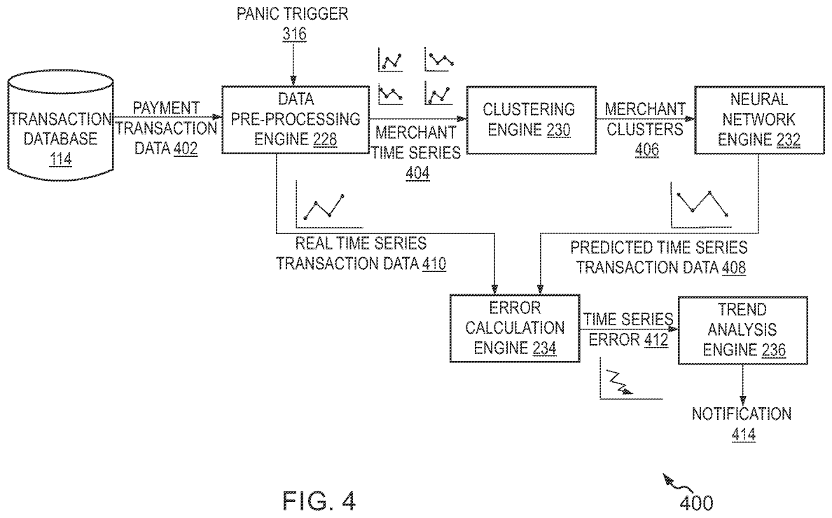

FIG. 4 is a schematic block diagram representation 400 of the panic states determination, in accordance with an example embodiment of the present disclosure. In response to receiving the panic trigger 316 from Model 2, the data pre-processing engine 228 accesses payment transaction data 402 associated with one or more merchants located in the region where situation of panic is predicted from the transaction database 114. The data pre-processing engine 228 converts the payment transaction data into transaction features or merchant time-series data 404. The data pre-processing engine 228 represents the time-series sales data into multivariate time-series data form based on aggregated sales amount and count of sales. Based on the transaction features or the merchant time-series data 404, the clustering engine 230 calculates an association between the merchant time-series data 404 and one or more merchant clusters 406, which are formed at the time of training the clustering engine 230 as explained with reference to FIG. 2.

Further, the neural network engine 232 predicts time-series transaction data associated with each merchant based on the association of the merchant time-series data 404 with the one or more merchant clusters 406. The neural network engine 232 includes cluster-specific marked temporal point process model. Each cluster-specific marked temporal point process model performs intensity-free learning over a merchant cluster using 2-D markers and transaction features to predict the time-series transaction data 408 associated with the merchant 102. Each merchant is associated with a unique merchant identifier (ID). The 2-D marker is represented in vector form and characterized by transaction amount and merchant ID. The predicted time-series transaction data for a merchant 102 can be calculated by substituting the merchant ID for the merchant 102 in the 2-D marker.

The error calculation engine 234 compares the predicted time-series transaction data 408 with real time-series transaction data 410. The real time-series transaction data 410 is accessed from the data-preprocessing engine 228 by the error calculation engine 234. The error calculation engine 234 calculates time-series error 412 between the real time-series transaction data 410 and the predicted time-series transaction data 408 for each merchant. The time-series error 412 is analyzed by the trend analysis engine 236 to determine the panic state of the merchant. The trend analysis engine 236 may utilize the conditions mentioned in the Table 1 to determine a panic state of the merchant. The trend analysis engine 236 further generates a notification indicating the panic state of merchant 414 in order to notify the merchant about its panic state or the government so as to take proper measures. It is to be noted that the panic state may be transmitted as an electronic message or displayed as a message or graphically presented on a user device of the merchant 102 or the government agency.

FIG. 5 is a schematic representation of a deep neural network model 500, in accordance with an example embodiment of the present disclosure.

As mentioned previously, the deep neural network model 500 may include, but not limited to, n cluster-specific marked TPP models (for the sake of clarity, only one cluster-specific marked TPP model is shown in the FIG. 5) corresponding to n merchant clusters. The deep neural network model 500 is configured to predict time-series transaction data of a particular merchant based on its identified merchant cluster of the particular merchant and corresponding 2D marker (transaction Amount, merchant identifier). In particular, the cluster-specific marked TPP model is trained based on intensity-free learning method. The processor 206 is configured to learn or model conditional distribution directly for each TPP model without assuming any conditional distribution initially. The goal is to model the distribution over inter-arrival time given the past history of events inter-arrival times i.e., learning to model the conditional distribution.

Each cluster-specific marked TPP model may utilize recurrent neural networks (RNN) to model conditional distributions of temporal process. In one embodiment, each cluster-specific TPP model may include an input layer 502, a recurrent layer 504, and an output layer 506.

In general, the RNN is a feed-forward neural network structure where additional edges, referred to as the recurrent edges, are added such that the outputs from the hidden units at the current time step are fed into them again as the future inputs at the next time step. In consequence, the same feed-forward neural network structure is replicated at each time step, and the recurrent edges connect the hidden units of the network replicated at adjacent time steps together along time, that is, the hidden units with recurrent edges not only receive the input from the current data sample but also from the hidden units in the last time step. This feedback mechanism creates an internal state of the network to memorize the influence of each past data sample. The RNN network learns non-linear dependency over both of the 2D marker and the timings of the past events.

In one embodiment, the input layer 502 is configured to feed embedded vector representation of 2D marker Yⱼ (transaction amount, merchant identifier) and transaction features Tⱼ to the recurrent layer 504. The recurrent layer 504 learns representations that summarize non-linear dependency over the past transaction data. Based on the learned representations, the recurrent layer 504 is configured to feed two outputs to the output layer 506. The two outputs 506a and 506b represents prediction probability of next 2D marker and transaction features, respectively and are used to calculate respective loss function.

In one embodiment, normalizing flows are utilized for learning conditional distribution. In another embodiment, a mixture of log-normal distributions is utilized for defining the conditional distribution.

During training, the processor 206 is configured to provide a combined transaction features of each merchant cluster along with corresponding 2D marker to each cluster-specific marked TPP model which learns conditional distribution over the payment transactions at various merchants associated with the merchant cluster.

For predicting time-series transaction data for a specific merchant, the processor 206 is configured to determine association of the specific merchant and at least one merchant cluster. A cluster-specific marked TPP model associated with the at least one merchant cluster is fed with two dimensional (2D) marker associated with the specific merchant and transaction features of a period of time. Thereafter, the cluster-specific marked TPP model predicts the time-series transaction data associated with the specific merchant.

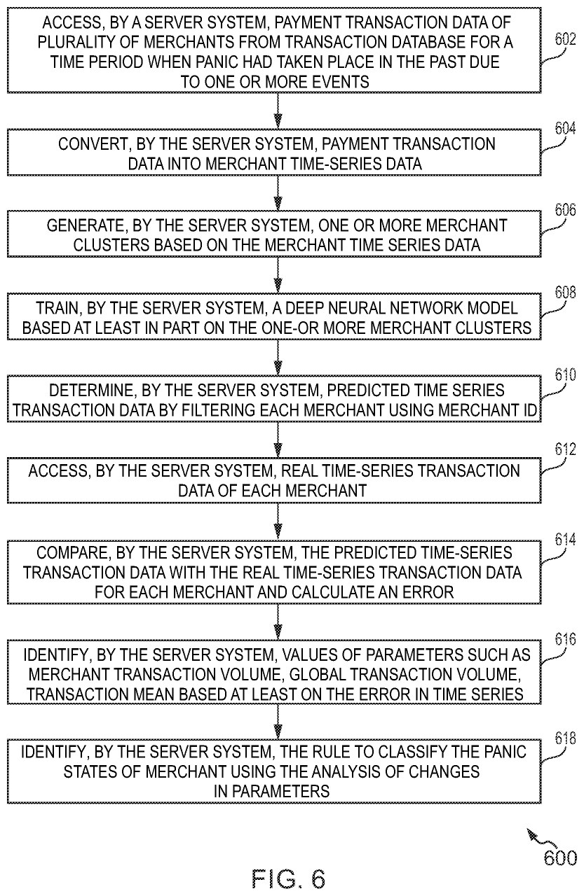

FIG. 6 is a flow chart 600 for training phase, in accordance with an embodiment of the present disclosure. The sequence of operations of the flow chart 600 may not be necessarily executed in the same order as they are presented. Further, one or more operations may be grouped and performed in form of a single step, or one operation may have several sub-steps that may be performed in parallel or in a sequential manner.

At 602, a server system, for e.g., the server system 200 as shown in FIG. 2, accesses payment transaction data (i.e., purchase transaction data) associated with a plurality of merchants over a period of time when the panic situation was created due to events (i.e. earthquake, pandemic, bomb threat etc.) in the past. The server system 200 accesses the payment transaction data from the transaction database 114. The server system 200 may fetch the data from a single or multiple acquirer servers corresponding to the plurality of merchants.

At 604, the server system 200 converts the payment transaction data into time-series transaction data of each merchant (i.e., merchant 102). It is noted that the merchants may have physical stores, or online store. In particular, the server system 200 aggregates merchant transaction attributes for each merchant of the plurality of merchants in a time-series manner.

At 606, the server system 200 generates a plurality of merchant clusters based, at least in part on, the time-series transaction data. The merchant clusters are formed based, at least in part, on the average rate of change in spend at the merchants' stores (online or offline).

Subsequent to generating the plurality of merchant clusters, at 608, the server system trains a deep neural network model to predict time-series transaction data for the merchant clusters based, at least in part, on time-series transaction data of the plurality of merchant clusters.

At 610, the server system 200 determines the predicted time-series transaction data for each merchant after filtering a merchant using the merchant identifier of the merchant using 2D markers.

At 612, the server system 200 accesses real-time transaction data associated with the filtered merchant and converts the real-time transaction data into real time-series transaction data by first extracting merchant transaction attributes from the real-time transaction data and subsequently aggregating the merchant transaction attributes to form the real-time transaction data.

At 614, the server system 200 compares the predicted time-series transaction data with the real time-series transaction data for the merchant filtered at step 610. In particular, the server system 200 calculates an error between the predicted time-series transaction data and the real time-series transaction data.

Steps 610, 612, and 614 are repeated for each merchant of the plurality of merchants. Once, the errors between the predicted time-series transaction data and the real-time-series transaction data are calculated for all the merchants, the server system 200, at 616, determines changes in various parameters like merchant transaction volume, global transaction volume, and transaction mean for all the merchants.

At 618, the server system 200 may identify the rule to classify the panic states of merchants using the analysis of changes in parameters calculated in step 616. In an example, the server system 200 may establish the rule as shown in the table 1.

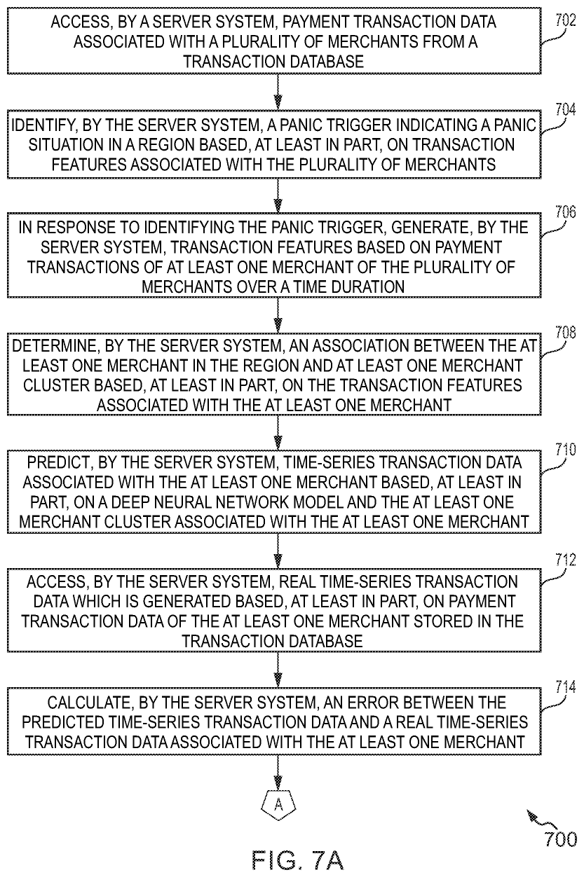

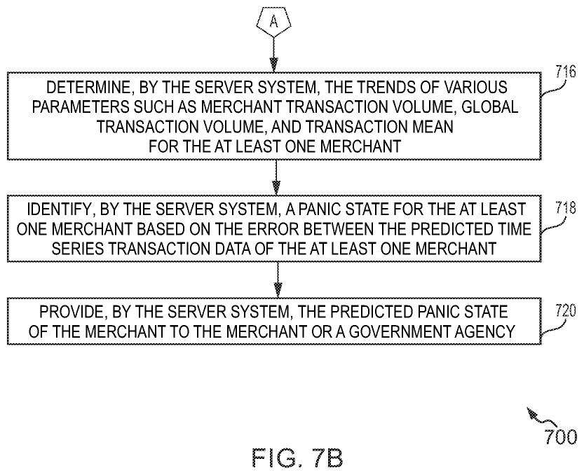

FIGS. 7A and 7B are flow charts of a computer-implemented method 700 for predicting a panic in a region and determining a panic state of a merchant in the region, in accordance with an example embodiment of the present disclosure. The method 700 depicted in the flow diagram may be executed by the server system 110 or the acquirer server 108 as explained with reference to FIG. 1. Operations of the method 700, and combinations of operation in the method 700, may be implemented by, for example, hardware, firmware, a processor, circuitry and/or a different device associated with the execution of software that includes one or more computer program instructions. It is noted that the operations of the method 700 can be described and/or practiced by using a system other than the server systems. The method 700 starts at operation 702.

At 702, the method 700 includes accessing, by the server system 110, payment transaction data associated with a plurality of merchants 102a-102c from a transaction database 114.

At 704, the method 700 includes identifying, by the server system 110, a panic trigger indicating a panic situation in a region based, at least in part, on transaction features associated with the one or more merchants. The process of identifying a panic trigger is explained in detail with reference to FIG. 3 above and is therefore not explained for the sake of brevity.

At 706, the method 700 includes generating, by the server system 110, transaction features based on payment transactions of at least one merchant of the plurality of merchants over a time duration in response to identifying the panic trigger.

At 708, the method 700 includes determining, by the server system 110, an association between the at least one merchant (for example, merchant 102a) in the region and at least one merchant cluster based, at least in part, on the transaction features associated with the at least one merchant 102a.

At 710, the method 700 includes predicting, by the server system 110, time-series transaction data associated with the at least one merchant 102a based, at least in part, on a deep neural network model and the at least one merchant cluster associated with the at least one merchant 102a.

At 712, the method 700 includes accessing real time-series transaction data which is generated based, at least in part, on payment transaction data of the at least one merchant 102a stored in the transaction database 114.

At 714, the method 700 includes calculating, by the server system 110, an error between the predicted time-series transaction data and a real time-series transaction data associated with the at least one merchant 102a.

At 716, the method 700 includes determining, by the server system 110, trends of various parameters such as merchant transaction volume, global transaction volume, and transaction mean for the at least one merchant 102a over the time duration.

At 718, the method 700 includes identifying, by the server system 110, a panic state for the at least one merchant 102a based on the error between the predicted time-series transaction data and the real time-series transaction data of the at least one merchant 102a. The server system 110 identifies the panic state based on the rule determined in the training phase. In an example, the server system may identify the panic state of the at least one merchant according to the conditions given in the Table 1.

At 720, the method 700 includes providing, by the server system 110, the predicted panic state of the merchant 102a to the merchant 102a so that the merchant 102a may plan in ahead of time appropriate measures to avoid situations like out of stock, hoarding, or panic buying. The server system 110a may also notify government about the panic states predicted for one or more merchants in a region so that the government can take measures beforehand. The sequence of operations of the method 700 need not to be necessarily executed in the same order as they are presented. Further, one or more operations may be grouped together and performed in form of a single step, or one operation may have several sub-steps that may be performed in parallel or in sequential manner.

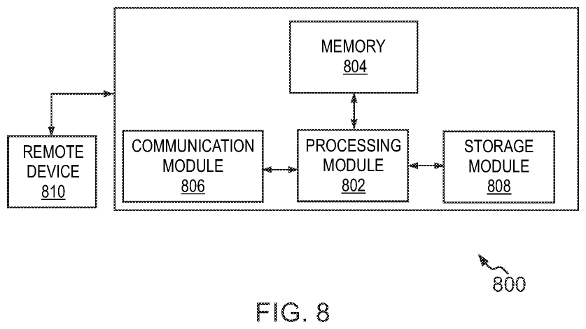

FIG. 8 is a simplified block diagram of an acquirer server 800 of the merchant 102, in accordance with an embodiment of the present disclosure. The acquirer server 800 is an example of the acquirer server 108 as shown in FIG. 1. The acquirer server 800 is associated with an acquirer bank or an acquirer, in which a merchant (e.g., the merchant 102) may have a payment account. The acquirer server 800 includes a processing module 802 operatively coupled to a memory module 804, a storage module 808 and a communication module 806. The components of the acquirer server 800 provided herein may not be exhaustive and the acquirer server 800 may include more or fewer components than those depicted in FIG. 8. Further, two or more components may be embodied in one single component, and/or one component may be configured using multiple sub-components to achieve the desired functionalities. Some components of the acquirer server 800 may be configured using hardware elements, software elements, firmware elements and/or combination thereof.

The storage module 808 is configured to store machine executable instructions to be accessed by the processing module 802. Additionally, the storage module 808 stores information related to, contact information of the user, bank account number, availability of funds in the account, payment card details, payment transaction information and/or the like.

The processing module 802 is configured to communicate with one or more remote devices such as a remote device 810 using the communication module 806 over a network, such as the network 116 of FIG. 1. The examples of the remote device 810 include a user device, a merchant device, and the server system 200 or other computing systems of issuer and the network 116 and the like. The communication module 806 is capable of facilitating such operative communication with the remote devices and cloud servers using API (Application Program Interface) calls. The processing module 802 receives, through the communication module 806, payment card information, a payment transaction amount, customer information, and merchant information in remote device 810 (i.e. the server system 200).

The processing module 802 is configured to fetch payment transaction information requested by the server system from the storage module 808 or an external database (not shown in the figure) accessible to the acquirer server 800.

The disclosed methods 600 and 700 with reference to FIG. 6 and FIGS. 7A and 7B, or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations that are different than those which are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

We claim:

1. A server system, comprising:
a communication interface;
a memory comprising executable instructions; and
a processor communicably coupled to the communication interface and the memory, the processor configured to execute the executable instructions to cause the server system to:
access payment transaction data associated with a plurality of merchants from a transaction database,
identify a panic trigger indicating a panic situation in a region based, at least in part, on transaction features associated with the plurality of merchants,
in response to identifying the panic trigger, generate transaction features based on payment transactions of at least one merchant of the plurality of merchants over a time duration,
determine an association between the at least one merchant in the region and at least one merchant cluster based, at least in part, on the transaction features associated with the at least one merchant,
predict time-series transaction data associated with the at least one merchant based, at least in part, on a deep neural network model and the at least one merchant cluster associated with the at least one merchant,
calculate an error between the predicted time-series transaction data and a real time-series transaction data associated with the at least one merchant, wherein the real time-series transaction data is generated based, at least in part, on payment transaction data of the at least one merchant stored in the transaction database, and
identify a panic state for the at least one merchant based on the error between the predicted time-series transaction data and the real time-series transaction data of the at least one merchant.

2. The server system as claimed in claim 1, wherein the server system is further caused to:
extract transaction features from the payment transaction data associated with plurality of merchants, wherein the payment transaction data comprises information of payment transactions between a plurality of customers and the plurality of merchants for a period of time;
detect a panic level in the region based, at least in part, on the transaction features and an average rate of change in spend at the plurality of merchants for the period of time; and
determine probable panic in the region in case the panic level is above a pre-determined threshold value.

3. The server system as claimed in claim 2, wherein the server system is further caused to:
in response to detection of the probable panic in the region, access information from one or more external databases;
determine a cause of the probable panic based, at least in part, on an analysis of information by a natural language processing model;
predict the panic situation in the region based, at least in part, on the cause of the probable panic; and
generate the panic trigger indicating the panic situation in the region.

4. The server system as claimed in claim 1, wherein the deep neural network model comprises marked temporal point process (TPP) models with intensity free learning method, and wherein each marked TPP model corresponds to a merchant cluster.

5. The server system as claimed in claim 3, wherein the server system is further caused to:
provide the transaction features and two dimensional (2D) marker associated with the at least merchant to a cluster-specific marked TPP model associated with the at least one merchant cluster, wherein the 2D marker is characterized by transaction amount and merchant identifier of the at least one merchant; and
predict the time-series transaction data associated with the at least one merchant by the cluster-specific marked TPP model.

6. The server system as claimed in claim 1, wherein the panic state for the at least one merchant is one of: out of stock state, hoarding state, and panic buying state.

7. The server system as claimed in claim 1, wherein the server system is further caused to:
notify the identified panic state for the at least one merchant via a message signal on a user device associated with the at least one merchant and a government agency.

8. The server system as claimed in claim 1, wherein the transaction features comprise one or more of:
total purchase amount for a pre-determined duration spent at each merchant;
total purchase amount spent by a plurality of customers possessing different card types for the pre-determined duration;
total number of transactions by the plurality of customers having different card types for the pre-determined duration;
total number of online transactions performed at each merchant for the pre-determined duration; and
total numbers of transactions involving a payment card at each merchant for the pre-determined duration.

9. A computer-implemented method, comprising:
accessing, by a server system, payment transaction data associated with a plurality of merchants from a transaction database;
identifying, by the server system, a panic trigger indicating a panic situation in a region based, at least in part, on transaction features associated with the plurality of merchants;
in response to identifying the panic trigger, generating, by the server system, transaction features based on payment transactions of at least one merchant of the plurality of merchants over a time duration;
determining, by the server system, an association between the at least one merchant in the region and at least one merchant cluster based, at least in part, on the transaction features associated with the at least one merchant;
predicting, by the server system, time-series transaction data associated with the at least one merchant based, at least in part, on a deep neural network model and the at least one merchant cluster associated with the at least one merchant;
calculating, by the server system, an error between the predicted time-series transaction data and a real time-series transaction data associated with the at least one merchant, wherein the real time-series transaction data is generated based, at least in part, on payment transaction data of the at least one merchant stored in the transaction database; and
identifying, by the server system, a panic state for the at least one merchant based on the error between the predicted time-series transaction data and the real time series transaction data of the at least one merchant.

10. The computer-implemented method as claimed in claim 9, wherein the deep neural network model comprises marked temporal point process (TPP) models with intensity free learning method, and wherein each marked TPP model corresponds to a merchant cluster.

11. The computer-implemented method as claimed in claim 9, further comprising:
extracting, by the server system, transaction features from the payment transaction data associated with plurality of merchants, wherein the payment transaction data comprises information of payment transactions between a plurality of customers and the plurality of merchants for a period of time;
detecting, by the server system, a panic level in the region based, at least in part, on the transaction features and an average rate of change in spend at the plurality of merchants for the period of time; and
determining, by the server system, probable panic in the region in case the panic level is above a pre-determined threshold value.

12. The computer-implemented method as claimed in claim 11, further comprising:
in response to detection of the probable panic in the region, accessing, by the server system, information from one or more external databases;
determining, by the server system, a cause of the probable panic based, at least in part, on an analysis of information by a natural language processing model;
predicting, by the server system, the panic situation in the region based, at least in part, on the cause of the probable panic; and
generating, by the server system, the panic trigger indicating the panic situation in the region.

13. The computer-implemented method as claimed in claim 12, further comprising:
providing, by the server system, the transaction features and two dimensional (2D) marker associated with the at least merchant to a cluster-specific marked TPP model associated with the at least one merchant cluster, wherein the 2D marker is characterized by transaction amount and merchant identifier of the at least one merchant; and
predicting, by the server system, the time-series transaction data associated with the at least one merchant by the cluster-specific marked TPP model.

14. The computer-implemented method as claimed in claim 9, wherein the panic state for the at least one merchant is one of: out of stock state, hoarding state, and panic buying state.

15. The computer-implemented method as claimed in claim 9, further comprising:
notifying, by the server system, the identified panic state for the at least one merchant via a message signal on a user device associated with the at least one merchant and a government agency.

16. The computer-implemented method as claimed in claim 9, wherein the transaction features comprise one or more of:
total purchase amount for a pre-determined duration spent at each merchant;
total purchase amount spent by a plurality of customers possessing different card types for the pre-determined duration;
total number of transactions by the plurality of customers having different card types for the pre-determined duration;
total number of online transactions performed at each merchant for the pre-determined duration; and
total numbers of transactions involving a payment card at each merchant for the pre-determined duration.
